(19) United States
(12) Patent Application Publication
(10) Pub. No.: US 2024/0101342 A1
(43) Pub. Date: Mar. 28, 2024

(54) TARP APPARATUS FOR COVERING WASTE HAULER AND/OR RECEIVER BOXES

(71) Applicant: ABG Bag, Inc., Rockford, IL (US)

(72) Inventor: William Duffy Bennett, Chicago, IL (US)

(21) Appl. No.: 18/203,461

(22) Filed: May 30, 2023

Related U.S. Application Data
(60) Provisional application No. 63/326,127, filed on Mar. 31, 2022.

(51) Int. Cl. B65D 90/02

(52) U.S. Cl. CPC B65D 90/021; B60P 7/0876

(57) ABSTRACT

A tarp apparatus includes a bendable and foldable heavy duty tarp designed to cover the exposed end of receiver boxes and waste haulers to keep refuse in during transit. The tarp apparatus folds for easy storage, is made of heavy duty geotextile or any pliable material, and is reinforced with webbing for strength, with grommets and loops for additional attachment points. In addition, attached webbing and hooks easily secure the tarp apparatus to receiver boxes and/or waste hauler trucks while attached cam buckles or ratchets tight the tarp apparatus securely to the receiver boxes and/or waste haulers.

The present invention claims priority to U.S. Provisional Patent Application No. 63/326,127 titled, “Gorilla Diaper or Receiver Box Cover,” having a filing date of Mar. 31, 2022, which is hereby incorporated by reference in its entirety.

### FIELD OF THE INVENTION

The present invention relates to a tarp apparatus. Specifically, the tarp apparatus comprises a bendable and foldable heavy duty tarp designed to cover the exposed end of receiver boxes and waste haulers to keep refuse in during transit. The tarp apparatus folds for easy storage, is made of heavy duty geotextile or any pliable material, and is reinforced with webbing for strength, with grommets and loops for additional attachment points. In addition, attached webbing and hooks easily secure the tarp apparatus to receiver boxes and/or waste hauler trucks while attached cam buckles or ratchets tight the tarp apparatus securely to the receiver boxes and/or waste haulers.

### BACKGROUND OF THE INVENTION

Waste haulers are used to transport waste from one location to another and waste receiver boxes are typically used to collect waste at a location, such as for compaction and/or hauling. Often, waste haulers and/or receiver boxes have openings that may allow waste to inadvertently exit, especially when traveling from one location to another. Specifically, both waste haulers and receiver boxes may have large openings in a rear thereof, typically where waste is placed into the waste hauler or receiver box. When the waste haulers or receiver boxes become full, loose articles may fall from the opening thereof.

Prior solutions have included tying flat tarps around and over the openings in the waste haulers and/or receiver boxes. Typically, one places a flat tarp and tie-downs, including rope, bungees, or other like attachment means, to tie the tarp over the opening. The tarps, however, are generally incorrectly sized, being either too small or too large for the opening. If too small, then waste may still find its way out of the waste hauler or receiver box. If too large, then extra tarp material must be tied down. In addition, the tie-down ropes, straps, or bungee cords, may be attached to various locations on the tarp, such as through grommets and the like, but may not provide a sufficiently snug fit around on over the opening. Oftentimes, tie-downs can become loose during traveling.

A need, therefore, exists for an improved tarp apparatus for use with waste haulers, receiver boxes, or to cover an opening in any other storage compartment or transportation vehicle. Specifically, a need exists for an improved tarp apparatus that is heavy-duty and sufficiently strong to cover openings in waste haulers and/or receiver boxes. More specifically, a need exists for an improved tarp apparatus that sufficiently contains waste within waste haulers and/or receiver boxes and prevents ejection of the same, especially during travel of the waste haulers and/or receiver boxes.

Moreover, a need exists for an improved tarp apparatus that is bendable and easily storable. In addition, a need exists for an improved tarp apparatus that is reinforced for added strength and includes connection points for easy securing of the same to waste haulers and/or receiver boxes. Further, a need exists for an improved tarp apparatus that further includes webbing having cam buckles and/or ratchets for securely connecting the webbing to the waste haulers and/or receiver boxes.

### SUMMARY OF THE INVENTION

The present invention relates to a tarp apparatus. Specifically, the tarp apparatus comprises a bendable and foldable heavy duty tarp designed to cover the exposed end of receiver boxes and waste haulers to keep refuse in during transit. The tarp apparatus folds for easy storage, is made of heavy duty geotextile or any pliable material, and is reinforced with webbing for strength, with grommets and loops for additional attachment points. In addition, attached webbing and hooks easily secure the tarp apparatus to receiver boxes and/or waste hauler trucks while attached cam buckles or ratchets tight the tarp apparatus securely to the receiver boxes and/or waste haulers.

To this end, in an embodiment of the present invention, a tarp apparatus for disposing over an opening is provided. The tarp apparatus comprises: a base comprising a fabric; a first reinforcement strap extending from a first edge of the base to a second edge of the base, wherein the first reinforcement strap is rigidly held along its length to the base; and a first extension strap extending from the first edge of the base, wherein the first extension strap extends from the first reinforcement strap and is adjustable in its length.

In an embodiment, the base is made from a geotextile.

In an embodiment, the first extension strap is connected through a cam buckle or a ratchet for adjusting the length of the extension strap.

In an embodiment, the cam buckle or the ratchet is attached to a base strap that is rigidly held to the first reinforcement strap.

In an embodiment, the first reinforcement strap is stitched to the base.

In an embodiment, the base strap is stitched to the first reinforcement strap.

In an embodiment, the first reinforcement strap extends from a first side of the base to a second side of the base.

In an embodiment, the first reinforcement strap extends from a first corner of the base to a second corner of the base.

In an embodiment, the tarp apparatus further comprises: a first edge reinforcement strap disposed along a first edge of the base.

In an embodiment, the first edge reinforcement strap is folded over the first edge of the base and rigidly held to both the top of the base and the bottom of the base.

In an embodiment, the tarp apparatus further comprises: a first loop extending from the base.

In an embodiment, the first loop extends from beneath the first edge reinforcement strap.

In an embodiment, the tarp apparatus further comprises: a reflective material on the base.

In an embodiment, the tarp apparatus further comprises: a second reinforcement strap extending from a second edge of the base to a third edge of the base, wherein the second reinforcement strap is rigidly held along its length to the base; and a second extension strap extending from the second edge of the base, wherein the second extension strap extends from the second reinforcement strap and is adjustable in its length.

In an embodiment, the second reinforcement strap is stitched to the base.

In an embodiment, the first reinforcement strap and the second reinforcement strap cross each other on the base.

In an embodiment, the first extension strap comprises a connection element on an end thereof.

In an embodiment, the connection element is a hook.

In an embodiment, the tarp apparatus further comprises: a second extension strap extending from the second edge of the base, wherein the second extension strap extends from the first reinforcement strap and is adjustable in its length.

In an alternate embodiment of the present invention, a system is provided. The system comprises: a waste hauler or a receiver box having an opening and an amount of waste within the waste hauler or the receiver box; and the tarp apparatus wherein the tarp apparatus is disposed over the opening, wherein the first extension strap is attached to a connection element on the waste hauler or the receiver box.

It is, therefore, an advantage and objective of the present invention to provide improved tarp apparatus for use with waste haulers, receiver boxes, or to cover an opening in any other storage compartment or transportation vehicle.

Specifically, it is an advantage and objective of the present invention to provide an improved tarp apparatus that is heavy-duty and sufficiently strong to cover openings in waste haulers and/or receiver boxes.

More specifically, it is an advantage and objective of the present invention to provide an improved tarp apparatus that sufficiently contains waste within waste haulers and/or receiver boxes and prevents ejection of the same, especially during travel of the waste haulers and/or receiver boxes.

Moreover, it is an advantage and objective of the present invention to provide an improved tarp apparatus that is bendable and easily storable.

In addition, it is an advantage and objective of the present invention to provide an improved tarp apparatus that is reinforced for added strength and includes connection points for easy securing of the same to waste haulers and/or receiver boxes.

Further, it is an advantage and objective of the present invention to provide an improved tarp apparatus that further includes webbing having cam buckles and/or ratchets for securely connecting the webbing to the waste haulers and/or receiver boxes.

Additional features and advantages of the present invention are described in, and will be apparent from, the detailed description of the presently preferred embodiments and from the drawings.

These and other objectives and advantages of the invention will become more apparent from the following detailed description when taken in conjunction with the accompanying drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a top plan view of a tarp apparatus in an embodiment of the present invention.

FIG. 2 illustrates a close-up view of a connection strap and cam buckle on a side of the tarp apparatus in an embodiment of the present invention.

FIG. 3 illustrates a close-up view of a connection strap and cam buckle on a corner of the tarp apparatus in an embodiment of the present invention.

FIG. 4 illustrates a rear view of a receiver box for storing and/or hauling waste having a tarp apparatus attached thereto over an opening in an embodiment of the present invention.

While the invention is susceptible of various modifications and alternative constructions, a certain embodiment is shown in the drawings and described in detail below. It should be understood, however, that there is no intention to limit the invention to the specific form disclosed, but on the contrary, the intention is to cover all modifications, alternative constructions and methods, and equivalents falling within the spirit and scope of the invention.

### DETAILED DESCRIPTION OF THE INVENTION

The present invention relates to a tarp apparatus. Specifically, the tarp apparatus comprises a bendable and foldable heavy duty tarp designed to cover the exposed end of receiver boxes and waste haulers to keep refuse in during transit. The tarp apparatus folds for easy storage, is made of heavy duty geotextile or any pliable material, and is reinforced with webbing for strength, with grommets and loops for additional attachment points. In addition, attached webbing and hooks easily secure the tarp apparatus to receiver boxes and/or waste hauler trucks while attached cam buckles or ratchets tight the tarp apparatus securely to the receiver boxes and/or waste haulers.

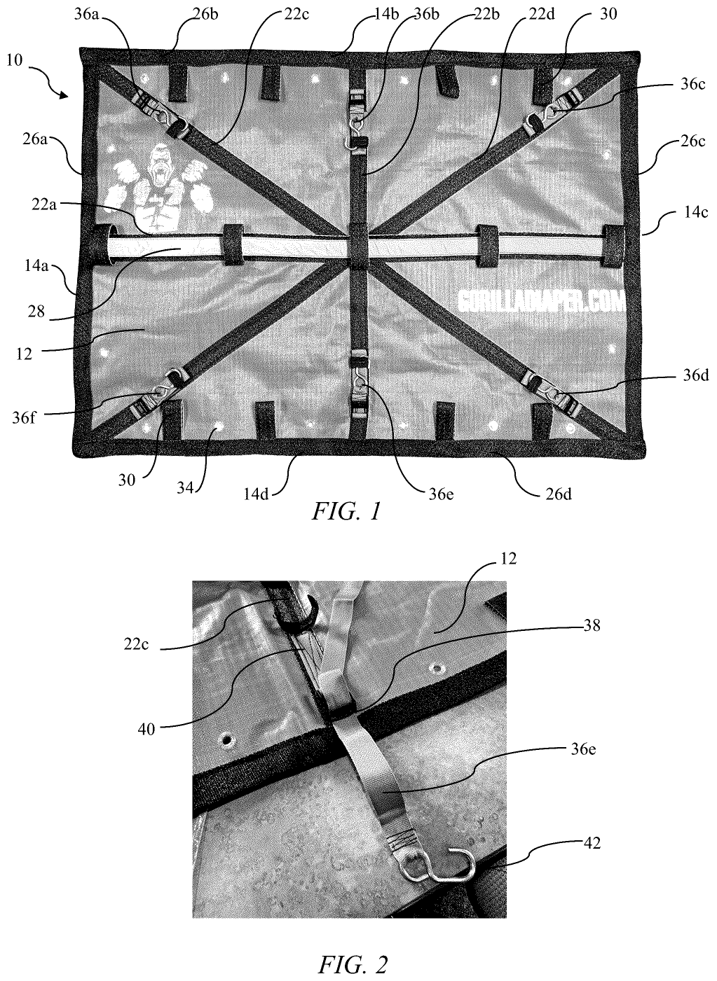

Referring now to FIG. 1, a flexible and foldable tarp apparatus 10 is illustrated in an embodiment of the present invention. Generally, the flexible and foldable tarp apparatus 10 may comprise a base 12 and sides 14a, 14b, 14c and 14d. The base 12 is generally square or rectangular in shape, as illustrated in FIG. 1, but may be any shape useful to disposed over openings of waste haulers and/or receiver boxes, as illustrated in FIG. 4 and described herein.

The base 12 may be made from a bendable and foldable heavy duty tarp, such as heavy-duty geotextile or any other pliable material that may have sufficient strength for use, as described herein, without breaking or tearing. Further, the base 12 may be made from a single layer or may be made of multiple layers of materials for different purposes. For example, the outer layer may be the heavy duty geotextile material, and an inner layer (not shown) may be a liquid impervious plastic sheeting material which may be stitched or otherwise adhered together. On the base 12 may be an absorbent pad (not shown) that may be useful for absorbing liquid that may leak or spill from waste haulers and/or receiver boxes. Generally, the liquid impervious layer and/or the absorbent pad may be the same shape and size of the base 12 to fully cover the base.

A horizontal reinforcing webbing strap 22a may extend from a left side 14a to a right side 14c. The strap 22a may be stitched or otherwise adhered to the base 12 and run at or about the midline between the top side 14b and the bottom side 14d of the base 12. Likewise, a vertical reinforcing webbing strap 22b may extend from the top side 14b to the bottom side 14d and may be stitched or otherwise adhered to the base 12 and run at or about the midline between the left side 14a and the right side 14c of the base 12. In addition, a first diagonal reinforcing webbing strap 22c may extend from a top left corner of the base 12 to the bottom right corner of the base 12. The strap 22c may be stitched or otherwise adhered to the base 12 and may be stitched or otherwise adhered to the base 12. Moreover, a second diagonal reinforcing webbing strap 22d may extend from a top right corner of the base 12 to the bottom left corner of the base 12. Each of the straps 22a, 22b, 22c, 22d may run across the entire face of the base 12, through a center 24 and provide reinforcement to the base 12 for holding objects within waste haulers and/or receiver boxes, as described below with reference to FIG. 4.

In addition, a first peripheral webbing strap 26a may be stitched or otherwise adhered on the side 14a; a second peripheral webbing strap 26b may be stitched or otherwise adhered on the side 14b; a third peripheral webbing strap 26c may be stitched or otherwise adhered on the side 14c; and a further peripheral webbing strap 26d may be stitched or otherwise adhered on the side 14d. These peripheral webbing straps may be folded over the edges of the base 12 and stitched onto the base 12 on the top side and the bottom side (not shown) thereof.

Disposed in various locations around the periphery of the base 12 may be one or more webbing strap loops 30 that may be stitched under one or more of the webbing straps 26a, 26b, 26c, or 26d. Preferably, the loops 30 may extend at a first end thereof from beneath the webbing straps 26a, 26b, 26c, or 26d, extend back to form a loop, and extend at a second end thereof back under the webbing straps 26a, 26b, 26c, or 26d. Preferably, the first and second ends of the loops 30 may be stitched and held to the base 12 beneath one of the webbing straps 26a, 26b, 26c, or 26d, thereby providing strength and resiliency to the loops 30, especially in use thereof.

One or more strap loops 32 may extend from the horizontal webbing strap 22a to form connection positions for tying ropes, straps, bungees, or other like items, thereto. A first end of the strap loops 32 may extend from beneath one side of the horizontal webbing strap 22a, extend around to a second side of the horizontal webbing strap 22a, and a second end of the strap loop 32 may be disposed beneath the second side of the horizontal webbing strap 22a, thereby forming the loop. Preferably, the first and second ends of the loops 32 may be stitched and held to the base 12 beneath the horizontal webbing straps 22a, thereby providing strength and resiliency to the loops 32, especially in use thereof.

Disposed on the horizontal webbing strap 22 may be a reflective material 28 so that when the tarp apparatus 10 is disposed on a waste hauler or receiver box, the tarp apparatus 12 may be highly visible, especially at night on a roadway. A vehicle's headlights may therefore reflect on the reflective material 28, providing heightened visibility thereto.

A plurality of grommets 34 may be disposed in various locations around the base 12, as illustrated in FIG. 1, to provide further connection points for the attachment of items, such as ropes, straps, bungee cords, or other like objects. Preferably, the grommets are disposed near or adjacent to the peripheral edges of the base 12.

Disposed on the reinforcement straps near the periphery of the tarp apparatus may be one or more extension straps 36a, 36b, 36c, 36d, 36e, and 36f, that are attached to the base layer 12 through a cam buckle, a rather, or other adjustable element. FIG. 2 illustrates a close-up view of extension strap 36e in an embodiment of the present invention. Specifically, extension strap 36e may extend from a cam buckle 38 which may be connected to a base strap 40 that may be stitched to the vertical reinforcement strap 22b. Thus, the length of the extension strap 36e may be adjusted so that a hook 42 disposed on an end of the extension strap 36e may be connected to a connection element on the waste hauler or receiver box.

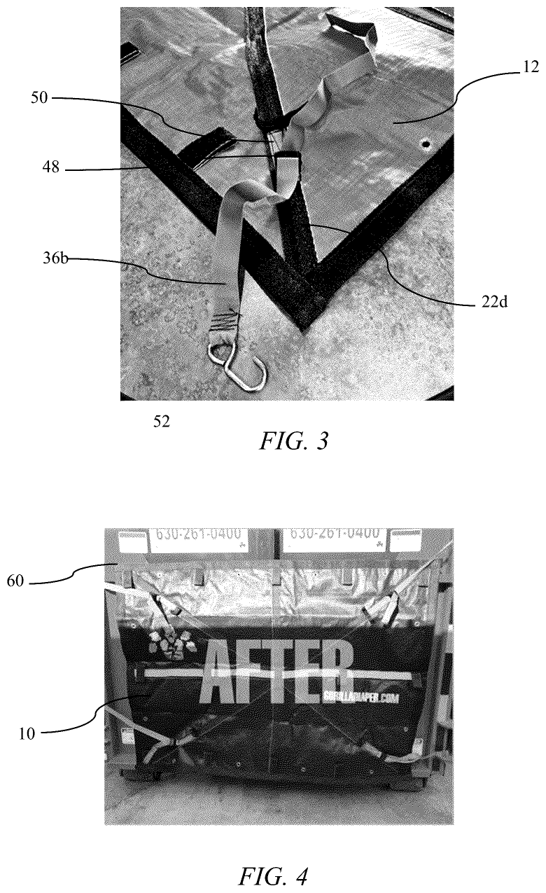

Likewise, FIG. 3 illustrates a close-up view of extension strap 36d in an embodiment of the present invention. Specifically, extension strap 36d may extend from a cam buckle 48 which may be connected to a base strap 50 that may be stitched to the first diagonal reinforcement strap 22c. Thus, the length of the extension strap 36d may be adjusted so that a hook 52 disposed on an end of the extension strap 36d may be connected to a connection element on the waste hauler or receiver box.

The extension straps 36a-36f may extend preferably from the reinforcement straps 22b, 22c, and 22d. However, while not shown in FIG. 1, additional extension straps may also extend from the horizontal reinforcement strap 22a, and the present invention should not be limited as described and shown herein.

A user of the tarp apparatus 10 may utilize one or more extension straps 36a-36f to tie-down the tarp apparatus 10 to a rear of the waste hauler and/or receiver box. As noted, the cam buckles may instead of ratchets or any other adjustable element that allows the straps to be extended or contracted as needed. Therefore, the tarp apparatus 10 may be placed over an opening and tightened down to provide a snug fit over the opening of the waste hauler or box receiver.

Specifically, FIG. 4 illustrates tarp apparatus 10 disposed over an opening of a receiver box 60 to ensure that waste contained therein remains within the receiver box 60. Of course, the tarp apparatus 10 may be applied over an opening of a waste hauler or other similar object and the present invention should not be limited as described herein. As shown, extension straps 36a, 36c, 36d, and 36f extend from the base 12 and are used to tie down to connection elements contained on the receiver box 60.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A tarp apparatus for disposing over an opening comprising:
a base comprising a fabric;
a first reinforcement strap extending from a first edge of the base to a second edge of the base, wherein the first reinforcement strap is rigidly held along its length to the base; and
a first extension strap extending from the first edge of the base, wherein the first extension strap extends from the first reinforcement strap and is adjustable in its length.

2. The tarp apparatus of claim 1 wherein the base is made from a geotextile.

3. The tarp apparatus of claim 1 wherein the first extension strap is connected through a cam buckle or a ratchet for adjusting the length of the extension strap.

4. The tarp apparatus of claim 3 wherein the cam buckle or the ratchet is attached to a base strap that is rigidly held to the first reinforcement strap.

5. The tarp apparatus of claim 1 wherein the first reinforcement strap is stitched to the base.

6. The tarp apparatus of claim 4 wherein the base strap is stitched to the first reinforcement strap.

7. The tarp apparatus of claim 1 wherein the first reinforcement strap extends from a first side of the base to a second side of the base.

8. The tarp apparatus of claim 1 wherein the first reinforcement strap extends from a first corner of the base to a second corner of the base.

9. The tarp apparatus of claim 1 further comprising:
a first edge reinforcement strap disposed along a first edge of the base.

10. The tarp apparatus of claim 9 wherein the first edge reinforcement strap is folded over the first edge of the base and rigidly held to both the top of the base and the bottom of the base.

11. The tarp apparatus of claim 9 further comprising:
a first loop extending from the base.

12. The tarp apparatus of claim 11 wherein the first loop extends from beneath the first edge reinforcement strap.

13. The tarp apparatus of claim 1 further comprising:
a reflective material on the base.

14. The tarp apparatus of claim 1 further comprising:
a second reinforcement strap extending from a second edge of the base to a third edge of the base, wherein the second reinforcement strap is rigidly held along its length to the base; and
a second extension strap extending from the second edge of the base, wherein the second extension strap extends from the second reinforcement strap and is adjustable in its length.

15. The tarp apparatus of claim 14 wherein the second reinforcement strap is stitched to the base.

16. The tarp apparatus of claim 14 wherein the first reinforcement strap and the second reinforcement strap cross each other on the base.

17. The tarp apparatus of claim 1 wherein the first extension strap comprises a connection element on an end thereof.

18. The tarp apparatus of claim 17 wherein the connection element is a hook.

19. The tarp apparatus of claim 1 further comprising:
a second extension strap extending from the second edge of the base, wherein the second extension strap extends from the first reinforcement strap and is adjustable in its length.

20. A system comprising:
a waste hauler or a receiver box having an opening and an amount of waste within the waste hauler or the receiver box; and
the tarp apparatus of claim 1 wherein the tarp apparatus is disposed over the opening, wherein the first extension strap is attached to a connection element on the waste hauler or the receiver box.
